(19) United States
(12) Patent Application Publication
(10) Pub. No.: US 2009/0319373 A1
(43) Pub. Date: Dec. 24, 2009

(54) NATIONAL ADVERTISEMENT LINKING

(75) Inventor: Peter T. Barrett, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,827

(22) Filed: Jun. 23, 2008

(51) Int. Cl. G06Q 30/00; H04N 7/025

(52) U.S. Cl. 705/14.55; 725/32; 725/34

(57) ABSTRACT

National advertisement linking is described. In embodiment(s), a bookmark can be received from a media device when the bookmark is initiated while an advertisement is rendered by the media device, such as when the bookmark is initiated by a viewer at the media device. The bookmark can be correlated with the advertisement, and a product or service that is advertised in the advertisement can be determined. Providers of the product or service that is advertised in the advertisement can then be determined, such as a local provider of the product or service that is advertised in a national advertisement.

### BACKGROUND

Viewers have an ever-increasing selection and variety of media content to choose from, such as television programming, movies, music, and/or recorded media content. Given the variety of media content that is available, as well as the many devices that can be utilized for viewing and/or playback of the media content, viewers may want to identify and locate particular television programming, movie choices, music, or advertisements that is of interest to them. Advertisements are an example of media content that a viewer may want to identify for future reference of a product or service that is advertised in an advertisement.

### SUMMARY

This summary is provided to introduce simplified concepts of national advertisement linking. The simplified concepts are further described below in the Detailed Description. This summary is not intended to identify essential features of the claimed subject matter, nor is it intended for use in determining the scope of the claimed subject matter.

National advertisement linking is described. In embodiment(s), a bookmark can be received from a media device when the bookmark is initiated while an advertisement is rendered by the media device, such as when the bookmark is initiated by a viewer at the media device. The bookmark can be correlated with the advertisement, and a product or service that is advertised in the advertisement can be determined. Providers of the product or service that is advertised in the advertisement can then be determined, such as a local provider of the product or service that is advertised in a national advertisement.

In other embodiment(s), a request for a bookmark can be received, such as when a request to view a bookmark that corresponds to an advertisement is initiated by a viewer at a media device. When the request for the bookmark is received, the providers of the product or service that is advertised in the corresponding advertisement can be updated, and contact information for each of the providers can be communicated to the media device from which the request is received. A response to a media device from which a request for a bookmark is received can also include, but is not limited to, a local advertisement for the product or service that is advertised in the advertisement, a video program of the product or service, and/or a Web site address that correlates to the product or service.

### BRIEF DESCRIPTION OF THE DRAWINGS

Embodiments of national advertisement linking are described with reference to the following drawings. The same numbers are used throughout the drawings to reference like features and components:

FIG. 1 illustrates an example system in which embodiments of national advertisement linking can be implemented.

FIG. 2 illustrates another example system in which embodiments of national advertisement linking can be implemented.

FIG. 3 illustrates example method(s) for national advertisement linking in accordance with one or more embodiments.

FIG. 4 illustrates example method(s) for national advertisement linking in accordance with one or more embodiments.

FIG. 5 illustrates various components of an example device which can implement embodiments of national advertisement linking.

### DETAILED DESCRIPTION

Embodiments of national advertisement linking provide that a viewer or other user at a media device can initiate and create a bookmark that corresponds to an advertisement, such as by pressing a “bookmark” selectable button on a remote control device. The viewer can then later request to “view”, “play”, or “share” the bookmark that corresponds to the advertisement. The bookmark that corresponds to an advertisement can be received from the media device when initiated while the advertisement is rendered by the media device. A bookmark can be initiated or created as an identifier or reference that corresponds to a specific advertisement, or segment thereof. A bookmark can also optionally indicate start and/or end points that define the advertisement.

A product or service that is advertised in an advertisement that has been bookmarked can be determined, and providers of the product or service can also be determined. In an embodiment, local provider(s) of the product or service that is advertised in a national advertisement can be determined and provided as contact information to a viewer that initiates and/or requests to view a bookmark that corresponds to the national advertisement. A response for a request to view a bookmark that corresponds to an advertisement can include not only the contact information for a provider of the product or service advertised in the advertisement, but can also include a local advertisement for the product or service, a video program of the product or service, and/or a Web site address that correlates to the product or service.

In addition, the providers of the product or service that is advertised in an advertisement can be updated each time that a request is received for the bookmark that corresponds to the advertisement. The providers of the product or service can be interpreted or updated “live”, such as when a request for a selected bookmark is received. This may also be referred to as “late-binding” a bookmark to update and/or re-determine a context of the bookmark to the various providers of the product or service advertised in the advertisement. A bookmark user interface can then be displayed at a media device from which a viewer can select the various providers of the product or service that have been associated or correlated with a selected bookmark.

While features and concepts of the described systems and methods for national advertisement linking can be implemented in any number of different environments, systems, and/or various configurations, embodiments of national advertisement linking are described in the context of the following example systems and environments.

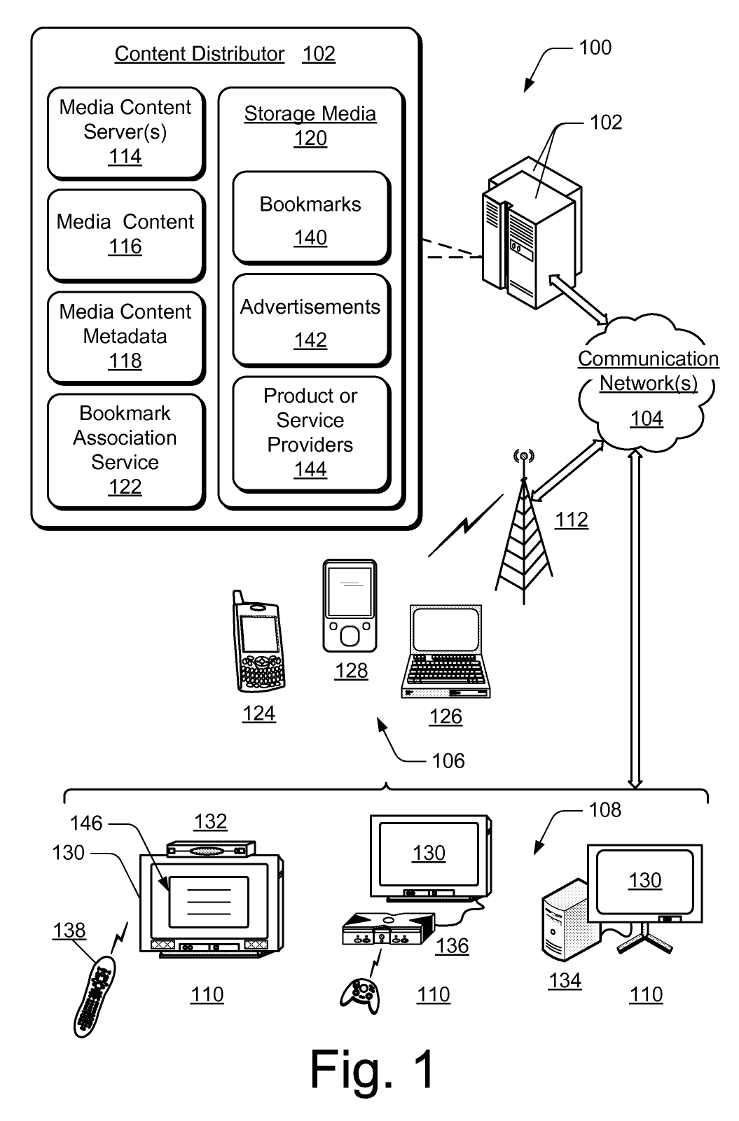

FIG. 1 illustrates an example system 100 in which various embodiments of national advertisement linking can be implemented. In this example, system 100 includes one or more content distributors 102 that communicate or otherwise provide media content to any number of various media devices via communication network(s) 104. The various media devices can include wireless media devices 106 as well as other media devices 108 (e.g., wired and/or wireless client devices) that are implemented as components in various client systems 110. In a media content distribution system, the content distributors 102 facilitate the distribution of media content, content metadata, and/or other associated data to multiple viewers, users, viewing systems, and devices.

The communication network(s) 104 can be implemented to include any type of data network, voice network, broadcast network, an IP-based network, a wide area network (e.g., the Internet), and/or a wireless network 112 that facilitates media content distribution and data communication between the content distributors 102 and any number of the various media devices. The communication network(s) 104 can also be implemented using any type of network topology and/or communication protocol, and can be represented or otherwise implemented as a combination of two or more networks. Any one or more of the arrowed communication links facilitate two-way data communication, such as from the content distributor 102 to a media device 108 (e.g., a client device) and vice-versa.

The content distributor 102 can include media content servers 114 that are implemented to communicate or otherwise distribute media content 116 and/or other data to any number of the various media devices 108 and wireless media devices 106. The media content 116 (e.g., to include recorded media content) can include any type of audio, video, and/or image media content received from any type of media content source. As described throughout, “media content” can include television programs (or programming), advertisements, commercials, music, movies, and on-demand media content. Other media content can include interactive games, network-based applications, and any other audio, video, and/or image content (e.g., to include program guide application data, user interface data, advertising content, closed captions data, content metadata, search results and/or recommendations, and the like).

Other media content can include media content metadata 118 that includes identifying criteria, descriptive information, and/or attributes associated with the media content 116 that can describe and categorize the media content. The metadata 118 associated with a television program, movie, or advertisement can be any form of information that describes and/or characterizes the media content. For example, metadata can include a program or movie identifier, a title, a subject description of the program, movie, or advertisement, a plot description, actor information, a date of production, broadcast channel, television network, artistic information, music compilations, and any other possible descriptive information about the media content. Further, metadata can characterize a genre that describes the media content as being an advertisement, a movie, a comedy show, a sporting event, a news program, a sitcom, a talk show, an action/adventure program, or as any number of other category descriptions.

In the example system 100, the content distributor 102 includes storage media 120 to store or otherwise maintain various data and media content, such as media content 116 and media content metadata 118. In a Network Digital Video Recording (nDVR) implementation, recorded on-demand assets can be recorded when initially distributed to the various media devices as scheduled television media content, and stored with the storage media 120 or other suitable storage device. The storage media 120 can be implemented as any type of memory, random access memory (RAM), read only memory (ROM), any type of magnetic or optical disk storage, and/or other suitable electronic data storage.

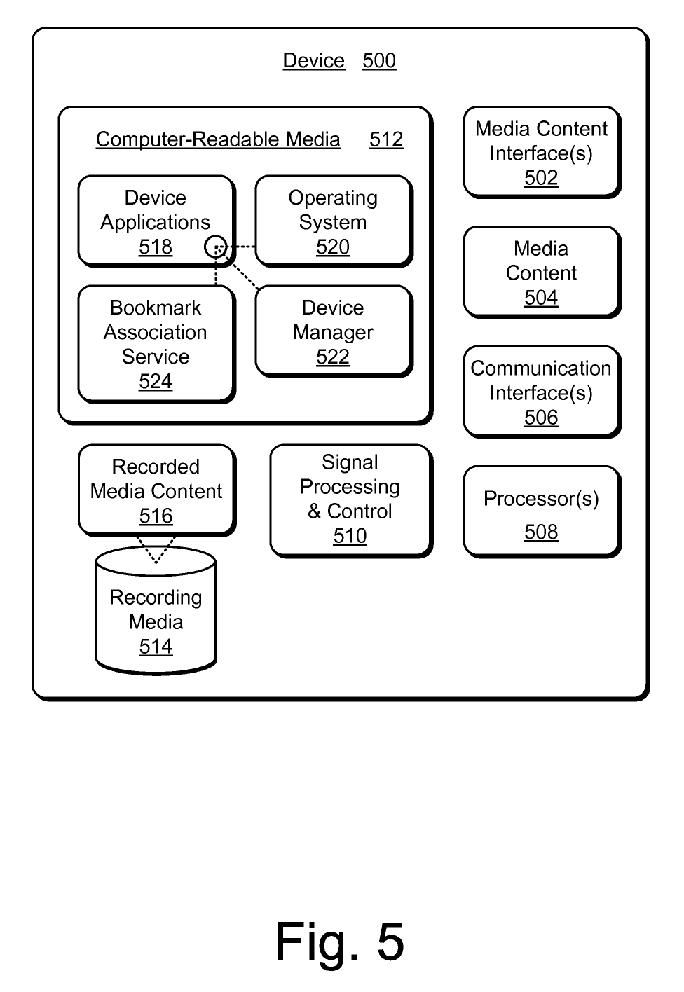

Content distributor 102 also includes a bookmark association service 122 that can be implemented as computer-executable instructions and executed by processor(s) to implement various embodiments and/or features of national advertisement linking. In addition, a content distributor 102 can be implemented with any number and combination of differing components as further described with reference to the example device shown in FIG. 5. Although illustrated and described as a component or module of the content distributor 102, the bookmark association service 122, as well as other functionality described to implement embodiments of national advertisement linking, can also be provided as a service apart from the content distributor 102 (e.g., on a separate server or by a third party service).

The wireless media devices 106 can include any type of device implemented to receive and/or communicate wireless data, such as any one or combination of a mobile phone device 124 (e.g., cellular, VoIP, WiFi, etc.), a portable computer device 126, a media device 128 (e.g., a personal media player, portable media player, etc.), and/or any other wireless media device that can receive media content in any form of audio, video, and/or image data. Each of the client systems 110 include a respective client device and display device 130 that together render or playback any form of audio, video, and/or image content, media content, and/or television content.

A display device 130 can be implemented as any type of a television, high definition television (HDTV), LCD, or similar display system. A client device in a client system 110 can be implemented as any one or combination of a television client device 132 (e.g., a television set-top box, a digital video recorder (DVR), etc.), a computer device 134, a gaming system 136, an appliance device, an electronic device, and/or as any other type of client device that can be implemented to receive television content or media content in any form of audio, video, and/or image data in a media content distribution system.

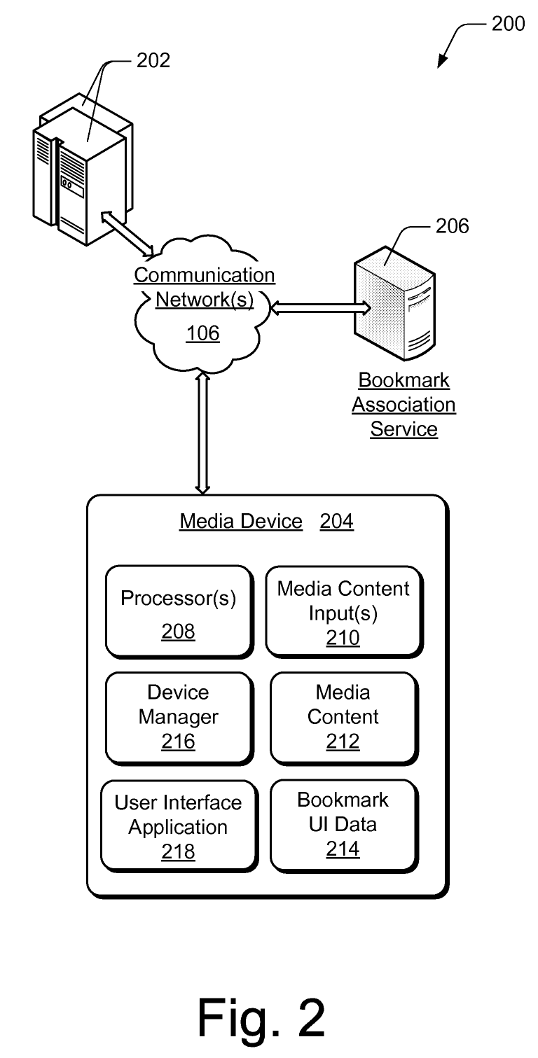

Any of the media devices can be implemented with one or more processors, communication components, memory components, signal processing and control circuits, and a media content rendering system. Further, any of the wireless media devices 106 and/or other media devices 108 (e.g., client devices) can be implemented with any number and combination of differing components as further described with reference to the example device shown in FIG. 2. A media device may also be associated with a user or viewer (i.e., a person) and/or an entity that operates the device such that a media or client device describes logical devices that include users, software, and/or a combination of devices.

In one or more embodiments, the bookmark association service 122 at content distributor 102 can receive a bookmark from any of the various media devices, such as when a user or viewer at a media device (e.g., television client device 132) initiates a bookmark with a remote control device 138. A bookmark that corresponds to an advertisement can be received from a media device when initiated while the advertisement is rendered by the media device, such as when an advertisement is rendered from a video stream of media content by the media device. In one or more embodiments, a bookmark can be received and maintained or otherwise persisted as a time indication of a position within the video stream and/or the media content from which the bookmark is initiated. The storage media 120 at content distributor 102 can be utilized to maintain or otherwise store the bookmarks 140 that are received from the various media devices.

Other techniques to discern a bookmark when initiated are contemplated, such as using a Web tool to mark start and end times or points for a video sub-segment of interest (e.g., that correlates to an advertisement in a video stream), using a remote control button (or buttons) to indicate the start and end times or points of the video sub-segment, indicating via a user interface that an advertisement is of interest (e.g., selecting a bookmark button on a remote control device to select an advertisement, or similar functionality in a Web-based environment), and other techniques.

When a bookmark 140 is received from any of the various media devices, the bookmark association service 122 can correlate the bookmark with an advertisement 142 and determine a product or service, or other retail offering, that is being advertised in the advertisement. In one embodiment, a product or service can be determined from the metadata 118 that is associated with an advertisement 142. The bookmark association service 122 can then determine providers 144 of the product or service that is advertised in an advertisement 142. For example, the bookmark association service 122 can determine that a particular brand of a new car is being advertised in a national auto commercial. The bookmark association service 122 can then determine local auto dealerships that may be offering the advertised new car for sale, where “local” is relative to a location, region, zip code, and/or other locality in which a media device is located when a bookmark save event is received.

The storage media 120 at content distributor 102 can be utilized to maintain the bookmarks 140 that correspond to the respective advertisements 142. In an embodiment, a bookmark 140 can be maintained as a bookmark definition that correlates the bookmark with an advertisement 142. For example, a bookmark definition of a bookmark 140 can correlate or otherwise associate the bookmark with a particular advertisement, a feature or other aspect of the advertisement, a product or service offered in or associated with the advertisement, and/or correlates or otherwise associates the bookmark with any other aspect of the advertisement.

The bookmark association service 122 can include various techniques to determine whether the media content from which a bookmark is initiated is an advertisement. In various embodiments, these techniques to determine an advertisement can be derived implicitly, or may be derived explicitly and provided in metadata that accompanies a media stream of media content. In one embodiment, the bookmark association service 122 can evaluate the media content metadata 118 that is associated with an advertisement 142 to determine the product or service that is being advertised. Other various techniques can be implemented to discern an advertisement that is spliced into a video stream of media content.

In one or more embodiments, the bookmark association service 122 at the content distributor 102 can receive a request to view a bookmark 140, such as when a viewer or other user at a media device initiates the request for the bookmark. The providers 144 of a product or service that are determined when an advertisement is bookmarked can change over time, and the bookmark association service 122 can update the providers 144 of the product or service that is advertised in the advertisement each time that a request is received for the bookmark that corresponds to the advertisement. The providers 144 of a product or service can be interpreted or updated “live”, such as when a viewer initiates a request for a bookmark. This feature may also be referred to as “late-binding” a bookmark to update and/or re-determine the contextual aspects of the bookmark to further identity other providers associated with the product or service that is advertised in an advertisement.

The bookmark association service 122 can then respond to the media device via which the request for the bookmark was received with contact information for each of the determined and/or updated providers 144 of the product or service. The bookmark association service 122 can provide or otherwise communicate the contact information for the providers to a media device (e.g., television client device 132) as a bookmark user interface 146 that displays a requested bookmark, the associated advertisement, and/or the contact information for the various providers of the product or service.

The bookmark association service 122 can also respond to a request for a bookmark 140 that corresponds to a particular national advertisement 142 with a local advertisement for the product or service. For example, the bookmark may correspond to the national auto commercial for the new car and the bookmark association service 122 can initiate providing a local advertisement for the new car so that the viewer who requested the bookmark can ascertain where in a local region the viewer can begin shopping for the car. The bookmark association service 122 may also respond to a request by providing a video program of the product or service, such as a thirty-minute video feature that advertises the new car in detail.

The bookmark association service 122 may also respond to a request by providing a Web site address that correlates to the product or service. For example, if a user at a computer initiates a request for a bookmark that corresponds to an advertisement for a household product, the bookmark association service 122 can respond to the request by providing a Web site address that has more information about the product, information about where to purchase the product, and/or coupons or other sales information relating to the purchase of the product. Similarly, if the user at the computer initiates the request for the bookmark that corresponds to the advertisement for the new car, the bookmark association service 122 can respond to the request by providing a Web site address for the manufacturer of the new car, an IP-based video service that includes video clips about the new car, and/or Web site addresses for local auto dealerships that offer the new car for sale.

In an embodiment, a provider of a product or service can be determined (e.g., late-bind, interpreted, and/or updated) based on a profile of a user from which a request is received for a bookmark 140 that is associated with an advertisement 142. A content distributor 102 in a media content distribution system can track previous user requests for various types of advertisements and media content, and based on previous user requests and media content preferences, the bookmark association service 122 can determine the contact information for those providers of a product or service that a viewer may want to contact. A provider 144 of a product or service can also be determined in combination with a day and/or time, current events, a social context, and/or any other aspect that can be utilized to conform the providers of a product or service to a particular viewer or user.

FIG. 2 illustrates an example system 200 in which various embodiments of national advertisement linking can be implemented. In this example, system 200 includes one or more content distributors 202 and an example of a media device 204. In various embodiments, media device 204 can be implemented as any one or combination of a wired and/or wireless media device, a mobile phone device, a portable computer device, a television client device (e.g., a television set-top box, a digital video recorder (DVR), etc.), a computer device, a gaming system, an appliance device, an electronic device, and/or as any other type of media device that may be implemented to receive media content in any form of audio, video, and/or image data. A viewer can interact with media device 204 and initiate viewer navigation inputs and selections of advertisements to create bookmarks with user inputs, such as on the portable media device or with a remote control input device.

An example of a content distributor is described with reference to content distributor 102 shown in FIG. 1. However, in this example system 200, a bookmark association service 206 is independent and implemented apart from content distributor 202 (e.g., on a separate server or by a third party service). The bookmark association service 206 can be implemented as an optional service and/or as a service that users pay for to receive bookmarked advertisements and media content. The content distributor 202, bookmark association service 206, and media device 204 can all be implemented for communication with each other via the communication network(s) 104 as described with reference to FIG. 1.

In the example system 200, media device 204 includes one or more processors 208 (e.g., any of microprocessors, controllers, and the like), media content inputs 210, and media content 212 (e.g., received media content, media content that is being received, recommended media content, recorded media content, etc.). The media content inputs 210 can include any type of wireless, broadcast, and/or over-the-air inputs via which any type of audio, video, and/or image media content can be received. The media content inputs 210 can also include Internet Protocol (IP) inputs over which streams of media content are received via an IP-based network. Media device 204 can also include one or more communication interfaces, such as a serial and/or parallel interface, a wireless interface, any type of network interface, a modem, and as any other type of communication interface. In addition, media device 204 can receive bookmark user interface data 214 from a content distributor 202 and/or the bookmark association service 206 via the media content inputs 210.

Media device 204 can also include a device manager 216 (e.g., a control application, software application, signal processing and control module, etc.) that can be implemented as computer-executable instructions and executed by the processors 208 to implement various embodiments and/or features of national advertisement linking. Media device 204 can also be implemented with any one or combination of hardware, firmware, or fixed logic circuitry. The device manager 216 can be implemented to monitor and/or receive selectable inputs (e.g., viewer selections, navigation inputs, etc.) via an input device, and initiate communication of user selections back to a content distributor 202 and/or to the bookmark association service 206.

Media device 204 can also include a user interface application 218 that can be implemented as computer-executable instructions and executed by the processors 208 to implement various embodiments and/or features of national advertisement linking. The user interface application 218 can process the bookmark user interface data 214 from which a bookmark user interface can be rendered and/or displayed for viewing at media device 204.

Media device 204 can also include an audio and/or video input/output system that provides audio data to an audio rendering system and/or provides video data to a display system. The audio rendering system and/or the display system can include any devices that process, display, and/or otherwise render audio, video, and image data. Video signals and audio signals can be communicated from media device 204 to an audio device and/or to a display device via an RF (radio frequency) link, S-video link, composite video link, component video link, DVI (digital video interface), analog audio connection, or other similar communication link. In an embodiment, an audio rendering system and/or display system can be implemented as external components to media device 204. Alternatively, an audio rendering system and/or display system can be implemented as integrated components of the example media device.

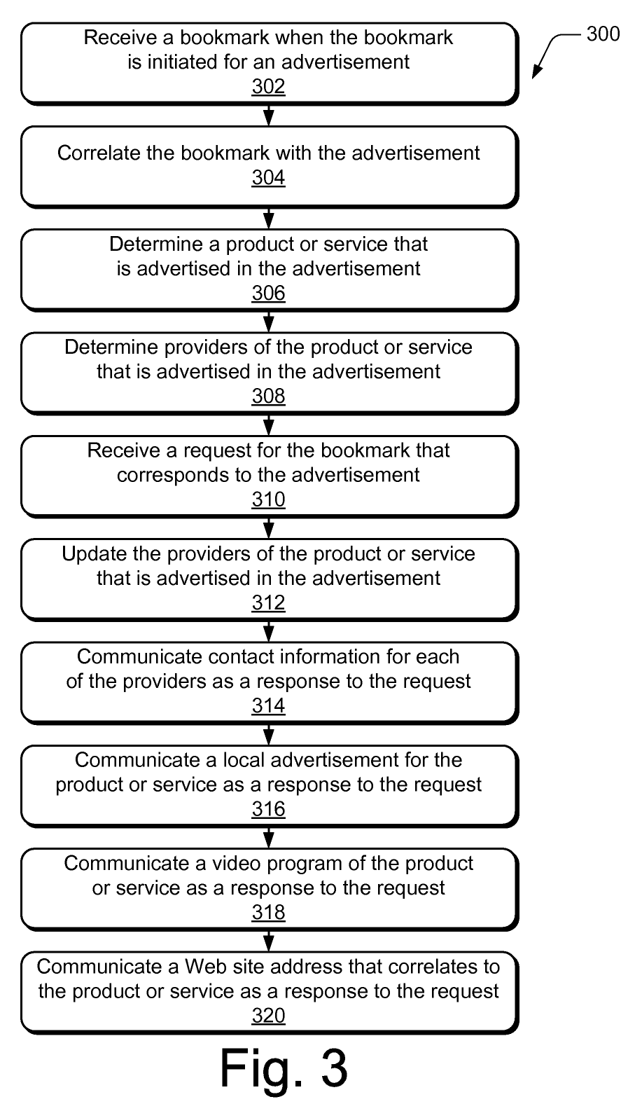

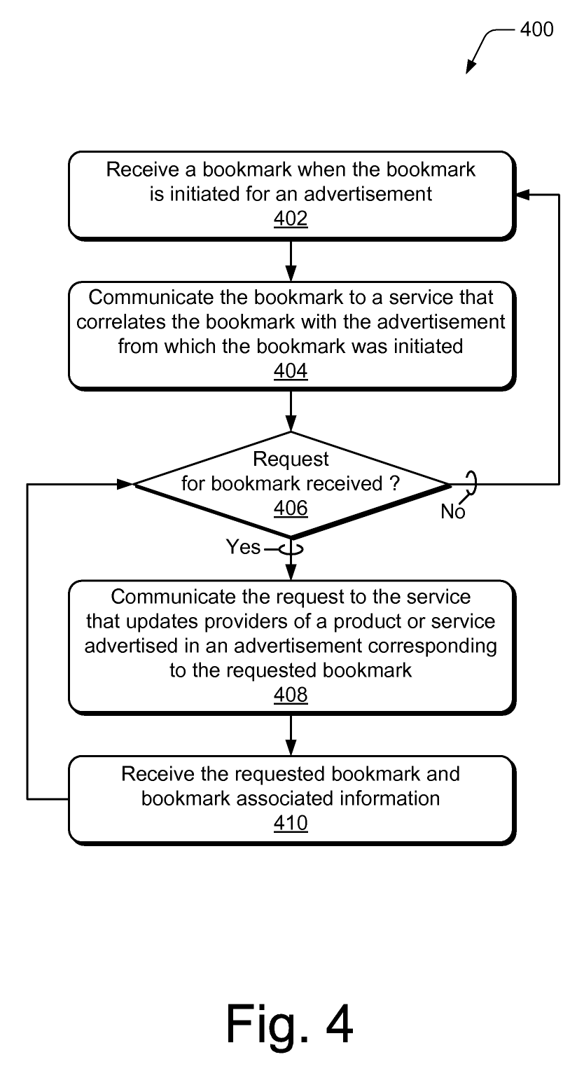

Example methods 300 and 400 are described with reference to respective FIGS. 3 and 4 in accordance with one or more embodiments of national advertisement linking. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example methods 300 and 400 may be described in the general context of computer-executable instructions which can include software, applications, routines, programs, objects, functions, methods, procedures, components, modules, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of national advertisement linking. The order in which the method is described is not intended to be construed as a limitation, and any number of the described method blocks can be combined in any order to implement the method, or an alternate method.

At block 302, a bookmark is received from a media device when the bookmark is initiated for an advertisement that is rendered by the media device. For example, the bookmark association service 122 at content distributor 102 (FIG. 1) receives a bookmark that is selected or otherwise initiated by a user at a media device (e.g., television client device 132), such as when the user is watching the advertisement.

At block 304, the bookmark is correlated with the advertisement. For example, the bookmark association service 122 correlates a bookmark 140 with an advertisement 142, and in an embodiment, a bookmark 140 can be maintained as a bookmark definition that correlates the bookmark with the advertisement 142. The content distributor 102 includes storage media 120 that maintains the selected bookmarks 140 as well as the corresponding advertisements 142. When a bookmark is initiated by a viewer or other user at a media device during an advertisement, the bookmark 140 is correlated with the advertisement 142 and/or with a product or service offered in the advertisement.

At block 306, a product or service that is advertised in the advertisement is determined. For example, the bookmark association service 122 at content distributor 102 determines a product or service, or other retail offering, that is being advertised in the advertisement. In one embodiment, a product or service can be determined from the metadata 118 that is associated with an advertisement 142.

At block 308, providers of the product or service that is advertised in the advertisement are determined. For example, the bookmark association service 122 at content distributor 102 determines providers 144 of the product or service that is advertised in an advertisement 142. In an embodiment, the bookmark association service 122 determines a local provider of the product or service from a national advertisement for the product or service.

At block 310, a request for the bookmark that corresponds to the advertisement is received. For example, the bookmark association service 122 at content distributor 102 receives a request to view a bookmark 140 that corresponds to an advertisement 142, such as when a viewer or other user at a media device initiates the request for the bookmark. A user or viewer at a media device can initiate a request for previously selected bookmarks (and corresponding advertisements), to include requests such as a bookmark view event, a bookmark play event, or a bookmark share event.

At block 312, the providers of the product or service are updated (e.g., re-determined or re-interpreted). For example, the providers 144 of a product or service that are determined when an advertisement 142 is bookmarked can change over time, and the bookmark association service 122 can update the providers 144 of the product or service that is advertised in an advertisement each time that a request is received for the bookmark that corresponds to the advertisement.

At block 314, contact information for each of the providers is communicated to the media device from which the request is received. For example, the bookmark association service 122 responds to the media device via which a request for a bookmark was received with contact information for each of the determined and/or updated providers 144 of the product or service, to include local providers of the product or service. The bookmark association service 122 can provide or otherwise communicate the contact information for the providers to a media device (e.g., television client device 132) as a bookmark user interface 146 that displays a requested bookmark, the corresponding advertisement, and/or the contact information for the various providers of the product or service.

At block 316, a local advertisement for the product or service is communicated to the media device from which the request for the bookmark is received. For example, the bookmark association service 122 responds to a request for a bookmark 140 that corresponds to a particular national advertisement 142 with a local advertisement for the product or service. A bookmark may correspond to a national auto commercial for a new car and the bookmark association service 122 initiates providing a local advertisement for the new car so that the viewer who requested the bookmark can ascertain where in a local region the viewer can begin shopping for the car.

At block 318, a video program of the product or service is communicated to the media device from which the request for the bookmark is received. For example, the bookmark association service 122 responds to a request for a bookmark by providing a video program of the product or service, such as a thirty-minute video feature that advertises the new car in detail.

At block 320, a Web site address that correlates to the product or service is communicated to the media device from which the request is received. For example, the bookmark association service 122 responds to a request by providing a Web site address that correlates to the product or service, such as if a user at a computer initiates a request for a bookmark that corresponds to an advertisement for a household product. The bookmark association service 122 responds to the request by providing a Web site address that has more information about the product, information about where to purchase the product, and/or coupons or other sales information relating to the purchase of the product.

FIG. 4 illustrates example method(s) 400 of national advertisement linking. The order in which the method is described is not intended to be construed as a limitation, and any number of the described method blocks can be combined in any order to implement the method, or an alternate method.

At block 402, a bookmark is received at a media device when a bookmark is initiated for an advertisement that is rendered by the media device. For example, a media device 204 (FIG. 2) receives a bookmark for an advertisement that is selected or otherwise initiated by a user at the media device that renders the media content 212 which includes the advertisement. At block 404, the bookmark is communicated to a service that correlates the bookmark with the advertisement from which the bookmark was initiated. For example, media device 204 communicates the bookmark for the advertisement to the bookmark association service 206 that determines providers of a product or service that is advertised in the advertisement.

At block 406, a determination is made as to whether a request for a bookmark is received. For example, a user or viewer at media device 204 can request previously selected bookmarks (and the corresponding advertisements). If a request for a bookmark is not received (i.e., “no” from block 406), then the method continues at block 402 to receive additional bookmarks when initiated by the viewer. If a request for a bookmark is received (i.e., “yes” from block 406), then at block 408, the request is communicated to the service that updates the providers of a product or service advertised in an advertisement corresponding to the requested bookmark. For example, media device 204 communicates the request for a bookmark to the bookmark association service 206 that updates (e.g., late-binds or re-interprets) the providers of the product or service advertised in the corresponding advertisement.

At block 410, the requested bookmark is received along with bookmark associated information. For example, media device 204 receives the bookmark user interface data 214 from the bookmark association service 206, and the user interface application 218 processes the data to render a bookmark user interface for display at the media device. The bookmark user interface can include contact information for each of the determined and/or updated providers of the product or service, to include local providers of the product or service. The bookmark associated information can also include, but is not limited to, a local advertisement for the product or service, a video program of the product or service, and/or a Web site address that correlates to the product or service.

FIG. 5 illustrates various components of an example device 500 that can be implemented as any form of a computer, electronic, appliance, and/or media device to implement various embodiments of national advertisement linking. For example, device 500 can be implemented as a content distributor, a media content server, or an independent bookmark association service as shown in FIG. 1 and/or FIG. 2. Device 500 can include one or more media content interfaces 502 via which any type of audio, video, and/or image media content 504 (e.g., television content) can be received from a media content source and/or distributed to media devices. The media content interfaces 502 can include Internet Protocol (IP) inputs over which streams of media content are received and/or distributed via an IP-based network.

Device 500 further includes one or more communication interfaces 506 that can be implemented as any one or more of a serial and/or parallel interface, a wireless interface, any type of network interface, a modem, and as any other type of communication interface. The communication interfaces 506 provide a connection and/or communication links between device 500 and communication network(s) by which other communication, electronic, and computing devices can communicate data and media content with device 500.

Device 500 can include one or more processors 508 (e.g., any of microprocessors, controllers, and the like) which process various computer-executable instructions to control the operation of device 500 and to implement embodiments of national advertisement linking. Alternatively or in addition, device 500 can be implemented with any one or combination of hardware, firmware, or fixed logic circuitry that is implemented in connection with signal processing and control circuits which are generally identified at 510.

Device 500 can also include computer-readable media 512, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 500 may also include a recording media 514 to maintain recorded media content 516 that device 500 receives and/or records (e.g., recorded television content, recorded on-demand media content, or assets).

Computer-readable media 512 provides data storage mechanisms to store media content 504, as well as various device applications 518 and any other types of information and/or data related to operational aspects of device 500. For example, an operating system 520, a device manager 522, and a bookmark association service 524 can each be maintained as a computer application and/or software module with the computer-readable media 512 and executed on the processors 508 to implement various embodiments of national advertisement linking.

Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of national advertisement linking have been described in language specific to features and/or methods, it is to be understood that the subject of the appended claims is not necessarily limited to the specific features or methods described. Rather, the specific features and methods are disclosed as example implementations of national advertisement linking.

1. A method, comprising:
receiving a bookmark from a media device when the bookmark is initiated while an advertisement is rendered by the media device;
correlating the bookmark with the advertisement;
determining a product or service that is advertised in the advertisement; and
determining one or more providers of the product or service that is advertised in the advertisement.

2. A method as recited in claim 1, wherein the advertisement is a national advertisement for the product or service, and wherein said determining the one or more providers includes determining a local provider of the product or service.

3. A method as recited in claim 1, further comprising receiving a request for the bookmark that corresponds to the advertisement, the request being received when initiated at the media device.

4. A method as recited in claim 3, further comprising communicating contact information for each of the one or more providers to the media device from which the request is received.

5. A method as recited in claim 4, further comprising updating the one or more providers of the product or service when receiving the request for the bookmark that corresponds to the advertisement.

6. A method as recited in claim 3, further comprising:
determining a local provider of the product or service when said determining the one or more providers; and
communicating contact information for the local provider to the media device from which the request for the bookmark is received.

7. A method as recited in claim 3, further comprising communicating a local advertisement for the product or service to the media device from which the request for the bookmark is received.

8. A method as recited in claim 3, further comprising communicating a video program of the product or service to the media device from which the request for the bookmark is received.

9. A method as recited in claim 3, further comprising communicating a Web site address that correlates to the product or service to the media device from which the request is received.

10. A content distributor, comprising:
a storage media configured to maintain bookmarks received from media devices when the bookmarks are initiated for advertisements;
a bookmark association service configured to:
receive a bookmark from a media device to create the bookmark that corresponds to an advertisement;
determine a product or service that is advertised in the advertisement; and
determine one or more providers of the product or service that is advertised in the advertisement.

11. A content distributor as recited in claim 10, wherein the advertisement is a national advertisement for the product or service, and wherein the bookmark association service is further configured to determine a local provider of the product or service.

12. A content distributor as recited in claim 10, wherein the bookmark association service is further configured to receive a request for the bookmark that corresponds to the advertisement, the request configured to be received when initiated at a media device.

13. A content distributor as recited in claim 12, wherein the bookmark association service is further configured to respond to the media device with contact information for each of the one or more providers to the product or service.

14. A content distributor as recited in claim 13, wherein the bookmark association service is further configured to update the one or more providers of the product or service when the request for the bookmark is received.

15. A content distributor as recited in claim 12, wherein the bookmark association service is further configured to:
determine a local provider of the product or service when the one or more providers are determined; and
respond to the media device with contact information for the local provider when the request for the bookmark is received.

16. A content distributor as recited in claim 12, wherein the bookmark association service is further configured to respond to the media device with a local advertisement for the product or service when the request for the bookmark is received.

17. A content distributor as recited in claim 12, wherein the bookmark association service is further configured to respond to the media device with a video program of the product or service when the request for the bookmark is received.

18. A content distributor as recited in claim 12, wherein the bookmark association service is further configured to respond to the media device with a Web site address that correlates to the product or service when the request for the bookmark is received.

19. One or more computer-readable media comprising computer-executable instructions that, when executed, direct a bookmark association service to:
receive a bookmark from a media device when the bookmark is initiated while an advertisement is rendered by the media device;
correlate the bookmark with the advertisement;
determine a product or service that is advertised in the advertisement; and
determine one or more providers of the product or service that is advertised in the advertisement.

20. One or more computer-readable media as recited in claim 19, further comprising computer-executable instructions that, when executed, direct the bookmark association service to determine a local provider of the product or service that is advertised in the advertisement.
